(19) United States
(12) Patent Application Publication
(10) Pub. No.: US 2007/0110996 A1
(43) Pub. Date: May 17, 2007

(54) METHOD FOR THE PROTECTION OF THERMOPLASTIC PLATES

(76) Inventors: Pierre Gerard, Denguin (FR); Alberto Luca Stasi, Rho (IT)

Correspondence Address: ARKEMA INC.;PATENT DEPARTMENT - 26TH FLOOR, 2000 MARKET STREET, PHILADELPHIA, PA, 19103-3222, US

(21) Appl. No.: 11/547,919

(22) PCT Filed: Apr. 5, 2005
(86) PCT No.: PCT/FR05/00824

§ 371 Date: Oct. 6, 2006

(30) Foreign Application Priority Data
Apr. 8, 2004 (FR) 0403697

(51) Int. Cl. B32B 7/12

(52) U.S. Cl. 428/343

(57) ABSTRACT

The present invention relates to the field of the protection, with masking films, of thermoplastic sheets, more especially acrylic resin sheets and polycarbonate sheets. The subject of the invention is a method for the protection of thermoplastic sheets using a multilayer film comprising polypropylene, and also the sheet thus coated.

The present invention relates to the field of the protection, with masking films, of thermoplastic sheets, more especially acrylic resin sheets and polycarbonate sheets. The subject of the invention is a method for the protection of thermoplastic sheets using a multilayer film comprising polypropylene, and also the sheet thus coated.

Certain thermoplastic polymers such as acrylic derivatives (especially polymethyl methacrylate, widely known by the initials PMMA,) and polycarbonate are routinely made into large rectangular sheets of variable thickness (for example, sheets 2 m wide by 3 m long and with a thickness between 2 mm and 15 mm). These sheets are obtained by various polymerization processes and/or molding, especially by casting or hot granule extrusion. Generally they are intended for the processors who use them, for example by cutting or thermoforming operations, with a view to fashioning the most varied of articles, such as bathtubs, cupolas for the building industry, or furniture.

Regarding especially PMMA, well known for its advantageous optical properties and its attractive appearance, it is common practice for industrial sheet producers to cover them with protective films, also called masking films. The purpose of this is to protect them from possible scratches, scuff marks or dust during storage, transport and more generally during all sheet manipulation and handling operations that occur between the time when it is made by the producer and the time when it is used by the processor.

It often happens that the processor, especially when the sheet is intended for thermoforming, wishes to carry out this operation on the sheet while it is still coated by the masking film, the latter being in contact with wall of the mould. This allows prolonged protection of the sheet during the thermoforming operation and even during the transport, storage and handling of the thermoformed article. As an example of such practice, mention may be made of the manufacture of acrylic resin bathtubs.

A protection method that is routinely practiced by PMMA sheet producers is known that comprises, by means of a suitable device, application of a polyethylene-based film to the sheet, where the film thickness is between 40 and 100 μm and generally close to 60 μm. In such a method the film and the sheet are brought to a temperature of between 20 and 100° C. The film is then tensioned and brought into contact with the sheet, and the assembly is pressed between two cylindrical rolls rotating in opposite directions that subject it to a pressure between 1 and 6 bar, and impart it with a translational movement in a horizontal plane corresponding to a speed of between 0.5 and 15 m/min.

As a result of this method, the film thus applied adheres to the sheet and protects it during the manipulation and handling operations that accompany its storage and transport by the manufacturer. It also adheres to the thermoformed sheet, and to the article thus formed (for example, a bathtub), during the storage and transport operations by the processor. The film is pulled off or debonded at a suitable time, generally by hand.

In the abovementioned arrangement, the film that has to be applied to the sheet is wound on a supply reel placed parallel to one of the edges of the sheet to be protected. This reel unwinds under the displacement action of the film adhering to the sheet after its application by the two press rolls, according to the translational movement described above. The film is then subjected to a certain tension, hereinafter denoted by the term “deposition tension”. This tension is capable, in turn, of bringing about a deformation or elongation of the film, so that the latter may be applied to the sheet and therefore adhere to it, with a certain deformation or elongation with respect to its rest state.

Such a deformation, even a small one, may result, on large rectangular sheets (for example 2 m by 3 m) in elongations that are significant in absolute value. Thus, on account of its mechanical properties, the film may subsequently, long after its application to the sheet (for example during storage of the sheet), shrink back to its original size, which may then lead to a localized or complete detachment of the film that is detrimental to the sheet protection quality.

Such phenomena are to be avoided.

To do so, it is necessary for the mechanical properties of the film to be such that it has the lowest possible deposition tension (when it unwinds from the abovementioned supply reel, in order to be applied to the sheet).

It is also necessary that the mechanical properties of the film be such that it has, for a fixed stress (or tension), the lowest possible deformation.

The adhesion of the masking film to the sheet must, lastly, be of good quality and stable over time. Such a property is represented by an adhesion test carried out 24 h after application of the film to the sheet, and which is described further on in the present text.

In addition, it is also necessary for the film to have a suitable tear strength. Such a strength is required on the one hand at the time of application of the film to the sheet, and on the other hand at the time when the end user (generally the processor or the user of the thermoformed article coated with the masking film) removes said protective film. In the latter case, the end user exerts a certain force that applies a stress to the film: for the sake of convenience it is preferable that the film does not tear into multiple fragments, but on the contrary that it is separated from the sheet while preserving its integrity, hence in a single go.

Finally, processors often desire to carry out a quality control relating to the possible presence of surface imperfections and/or faults in the thermoplastic sheet before forming it.

However, the polyethylene-based masking films generally reduce the contrast, and therefore the visibility, of the articles or details that they are covering. Such an effect, deriving from the optical properties of these films, is denoted by the term “haze”. Thus it is sometimes necessary to separate the film from the sheet in order to carry out an in-depth quality control of the thermoplastic sheet, then to replace it for the purpose of the thermoforming operation, which is a difficult operation. When the film is not separated from the sheet, and the quality control is carried out by visual inspection through the masking film, there is a risk of not detecting minor faults that will then appear on the thermoformed article after having removed the masking film therefrom.

It is desirable to limit such a risk by providing a masking film having an improved haze.

One object of the present invention is therefore to provide a method for the protection of thermoplastic sheets by a masking film, which facilitates quality control of the sheets owing to an improved haze, while keeping the effectiveness of the protection offered by polyethylene-based films.

Another object of the present invention is to provide a method for the protection of thermoplastic sheets that necessitates a smaller masking film thickness than the polyethylene films, while still having suitable mechanical properties, (especially a reduced film deposition tension and a low deformation when stressed), good adhesion that is stable over time and a suitable tear strength. The advantage of a smaller masking film thickness lies, other than in an appreciable decrease in the cost of the protection operation, in a reduction in the quantity of protective material. This is particularly beneficial when it is a question, after having removed the masking film, of disposing of it.

At present it has been found that these objects are completely or partly achieved by the method described hereinafter.

Thus the subject of the present invention is, in the first place, a method for the protection of a sheet of thermoplastic comprising the application to said sheet of a simultaneously coextruded and biaxially oriented film comprising the following layers:

a) a central layer of a propylene homopolymer or of a copolymer of propylene and ethylene and/or α-olefins having 4 to 8 carbon atoms, with an MFI (Melt Flow Index, ISO 1133, 230° C./10 min) of at least 1.5 to 10 g/10 min, preferably from 2 to 4 g/10 min;

b) an adhesive outer layer that comprises copolymers of ethylene and C₃ to C₁₂, preferably C₄ to C₈, α-olefins, with a density (ASTM 792) of 0.887 g/cm³ to 0.916 g/cm³ or ethylene/vinyl acetate (EVA) copolymers in which the vinyl acetate monomer represents from 2 to 14 mol %, said ethylene copolymers having an MFI (ASTM D 1238, 190° C./2.16 kg) of 1 to 10 g/10 min and preferably of 2 to 6 g/10 min, said layer b) being polarized on the surface;

the application of the multilayer film to the sheet being carried out, after Tensioning the film, by bringing the adhesive layer b) into contact with said sheet then passing the assembly between two cylindrical rolls rotating in opposite directions.

It has in fact been found that the multilayer film described above offers, owing to an improved haze in comparison to the polyethylene film, easier inspection of the faults likely to appear on the thermoplastic sheets and especially, owing to a lower deposition tension and a smaller deformation, better adhesion to the sheet that it protects.

The overall thickness of the multilayer film is between 15 μm and 50 μm, preferably between 15 μm and 35 μm, and even more preferentially between 20 μm and 30 μm. The thickness of the adhesive outer layer b) varies between 5 and 30%, preferably between 5 and 20% and more preferentially between 5% and 10% of the overall film thickness.

The quantity of comonomers in the propylene copolymers used in the central layer a) is between 0.1% and 40% by weight and preferably between 0.1% and 15% by weight. The α-olefins having 4 to 8 carbon atoms are for example, 1-butene, 1-hexene, 4-methyl-1-pentene and 1-octene.

The polymers used in layer a) are commercially available. By way of example, mention may be made of the one known under the trademark MOPLEN®HP522H (Basel).

Preferably a propylene homopolymer is used as the central layer a).

The ethylene copolymers of the adhesive layer b) are preferably copolymers of ethylene with C₄ to C₈ α-olefins, and they are preferably obtained by using, at the time of the polymerization, a metallocene-based catalyst 1.

For the latter, reference may be made, for example, to patent WO 91/11488 that describes catalysts based on organometallic coordination compounds which are cyclopentadienyl derivatives of a metal from Group 4b of the Periodic Table and comprise mono-, di- and tricyclopentadienyls and their derivatives with the transition metal. The catalyst 1 is generally used with a cocatalyst 2, chosen preferably from aluminoxanes 2a) that are products of the reaction of trialkylaluminum with water. Instead of aluminoxanes, compound 2b of the following formula may be used as the cocatalyst 2:
(L₁−H)⁺(A)⁻
in which:
(A)⁻is a compatible noncoordinating anion, preferably of formula (BQ_{q})⁻;
L₁ is a neutral Lewis base;
(L₁−H)⁺is a Brønsted acid;
B is an element from Groups IIIa to VIa of the Periodic Table of the Elements, with metalloid characteristics, preferably boron, phosphorus or arsenic with a valence state of 3 or 5, silicon and more preferably boron with a valence state of 3;
the Qs, which are identical to or different from one another, are selected from the following groups: hydride, halide, alkyl, aryl (possibly substituted, for example with halogens, preferably F), alkoside, aryloside, dialkylamido or R₀COO^{- where R}₀ counts as 1 to 20 carbon atoms, with the condition that Q can only be one halide at a time; and
q is an integer equal to the valence of B plus 1.

The molar ratio of Al from the aluminoxane compound 2a) to the quantity of metal from the catalyst 1 (metallocene) is between 10 000:1 and 100:1 and preferably between 5 000:1 and 500:1. In the case of the boron compound of formula 2b), the preferred metallocene/2b) ratio is between 0.1-0.4:1 and more preferentially between 0.5-2.0:1.

The polymerization processes for obtaining the ethylene/α-olefin copolymers of the adhesive outer layer b) are well known in the art—for example, reference may be made to those recommended in patent WO 91/11488.

The comonomers that may be used to prepare the ethylene copolymers of layer b) are for example, 1-butene, 1-hexene, 4-methyl-1-pentene and 1-octene. Some examples of said commercially available copolymers are those bearing the trademarks AFFINITY® PL 1880 and AFFINITY® PL 1850 (Dow).

It is preferred that an ethylene/vinyl acetate copolymer such as, for example GREENFLEX® (from Polimeri Europa), be used for layer b).

The adhesive layer b) may be polarized, for example by corona treatment or plasma treatment, preferably by corona treatment.

The coextruded film processed in accordance with the present invention may possibly be completed with a non-adhesive outer layer c) laid on the free surface of the central layer a), in order to improve the uniformity of the film thickness.

The thickness of the non-adhesive layer c) is between 5 and 30%, preferably between 5 and 20% and even more preferentially between 5% and 10% of the overall film thickness. The overall film thickness according to the present invention, which also includes layer c), lies within the limits defined above.

The non-adhesive layer c) is composed of a propylene homopolymer or of a copolymer with ethylene and/or an α-olefin having from 4 to 8 carbon atoms, with an MFI (ISO 1133, 230° C./10 min) of 2 to 10 g/10 min. The copolymers of propylene and ethylene and/or α-olefins having 4 to 8 carbon atoms used in c) have a comonomer content from 0.1% to 40% by weight and preferably from 0.1% by weight to 15% by weight.

The polymers used in layer c) are commercially available. By way of example, mention may be made of the one known by the name STAMYLAN®P 15E10FB (DSM).

The central layer a) may be composed of a single layer or of several layers, with recourse to the polymers and copolymers indicated at a).

To the multilayer film processed in accordance with the present invention may be added some conventional additives used in plastics, for example slip agents, antiblocking agents, antistatic agents, colorants and agents providing UV protection.

The simultaneously coextruded and biaxially oriented films applied in accordance with the present invention may be obtained by a method that can be carried out on a line that comprises:
an extruder for the central layer a), for example of the twin-screw type or two successive single-screw extruders, said extruder being connected to a vacuum pump in order to extract the air and to a feed pump in order to stabilize the output force;
single or twin-screw coextruders for the layers b) and optionally c);
a multilayer extrusion head (die) in order to obtain a composite foil formed from layers a), b) and possibly c);
a roll for quenching the foil, which can be obtained, for example, by immersing the roll in a water bath;
a system for preheating the foil, preferably by infrared radiation;
an oven for simultaneously drawing the foil, with the following sections, going in the direction of sheet travel: a pre-reheating section, a simultaneous drawing section, a stabilization section and a cooling section; and
a device for polarizing layer b) of the multilayer film obtained, for example a corona treatment or plasma treatment device.

The method for obtaining simultaneously coextruded and biaxially oriented films according to the present invention comprises the following steps:
preparation of a composite foil, preferably of a thickness between about 1.5 mm and 3.3 mm, by coextrusion of layers a), b) and optionally c), preferably through a sheet die and preferably using temperatures of between 160° C. and 270° C; and then quenching of the sheet, preferably carried out on a roll immersed in water and preferably at a temperature of 10° C. to 60° C.;
preheating of the foil to a temperature preferably between about 100° C. and about 120° C., preferably via infrared radiation;
simultaneous drawing, both in the machine direction MD and in the transverse direction TD of the foil, using the device described in United States patent U.S. Pat. No. 4,853,602 that is incorporated here in full by way of reference and in the following patents that describe this technology, and that comprise the following steps:
simultaneous drawing of the foil and formation of the film by gripping the edges of the foil with a series of clips or jaws that slide on two tracks and that are guided independently by synchronous linear induction motors, each clip or jaw sliding on a track and being driven by a permanent magnet or a pair of permanent magnets, propelled by the magnetic wave created by the salient poles of the linear motor; each section of the drawing device having a series of synchronous linear induction motors functioning in continuous mode, supplied by phase- and frequency-modulated AC current, in order to continuously vary the speed of the jaws and the relative speed between them, and therefore to vary the longitudinal draw ratios of the film, the transverse draw ratios being regulated by altering the divergence of the tracks on which the clips or jaws slide. The drawing device comprises one or more sections situated inside an oven having a temperature between about 150° C. and 190° C., and one or more sections situated in an oven having a temperature between about 130° C. and 140° C. In general, the longitudinal draw ratios are between about 4:1 and about 9:1 and preferably between 5.5:1 and 8.5:1, and the transverse draw ratios are between about 3:1 and about 8.5:1 and preferably between 5.5:1 and 8.5:1; and
polarization of layer b) of the film thus obtained.

The temperatures in the portions of the device described above are selected so as to optimize the biaxial orientation of the polymer films composed of the polymers used. To a first approximation, the longitudinal draw ratio may be considered to be equal to the ratio of the exit speed of the film from the drawing device (this speed being linked to the frequency of the current supplying the linear motors of the last section of the drawing device) to the entry speed of the film into the drawing device (this speed being linked to the frequency of the current supplying the linear motors of the first section of the drawing device). To a first approximation, the transverse draw ratio may be considered to be equal to the ratio of the film width on exiting the drawing device to the film width on entering the drawing device.

The corona treatment of the adhesive layer b) is preferably carried out by high-frequency electrical discharges, preferably with an intensity of 40 to 60 W/cm.

As indicated above, the multilayer film that has just been described is used for the protection of thermoplastic sheets. For this purpose it is applied, after it has been put under tension, by bringing the adhesive layer b) into contact with the sheet, then passing the assembly between two cylindrical rolls rotating in opposite directions. The processing temperature of the film is between 20° C. and 100° C. The film is placed on a reel having the same width as the surface of the sheet to be covered, in such a way that the reel unwinding direction coincides with the direction of sheet travel. The film adheres to the sheet surface due to its passing between two rolls that exert a pressure between, in general, 1 and 6 bar, the line speed being, in general, between 0.2 and 15 m/min.

The thermoplastics to which the protection of the sheets is applied are, according to the invention, chosen especially from acrylic resins, polycarbonate, polyethylene terephthalate and polyethylene glycol terephthalate.

However, among these thermoplastics acrylic resins, and more particularly polymethyl methacrylate (PMMA), are preferred.

Another subject of the present invention is the thermoplastic sheet coated with the coextruded film as defined above, the adhesive outer layer b) of said film being in contact with the sheet. Lastly, it relates to the article that can be obtained by thermoforming said sheet.

The following examples are given purely as an illustration of the method according to the invention, and they should not be used in any way to limit the scope thereof.

In these examples, characterization of the masking film is carried out in the following manner.

The film deformation is measured for an applied stress (or tension) of 10 MPa by means of a tensile test carried out according to the ASTM D 882 standard, and is hereinafter referred to as the “coefficient of deformation”.

The film haze is measured according to the ASTM D 1003 standard and is much better when it corresponds to a lower value.

### COMPARATIVE EXAMPLE 1

Application of a polyethylene film to a PMMA sheet:

An unoriented coextruded polyethylene film having a thickness of 60 μm was used. This film was representative of a film used industrially as a masking film for PMMA sheets. It had the following composition:
central layer: formed from LDPE (low-density polyethylene) possibly blended with LLDPE (linear low-density polyethylene) or with MDPE (medium-density polyethylene); and
the surface adhesive layer was composed of m-VLDPE (metallocene-based very low-density polyethylene).

The coefficient of deformation of this film was 5%. Its haze was 9.88.

A laboratory device was used as the application device, comprising:
a masking film supply reel;
rolls over which the film passed prior to its application to the sheet and of which one was fitted with a sensor measuring the tension that it bore;
a set of rolls that conveyed on the one hand the film, and on the other hand the sheet, into the vicinity of one another, just upstream of two 9 mm diameter cylindrical press rolls and of which the axes lay in the same vertical plane, separated by a distance of about 40 cm. One of these rolls was attached to a motor; and
a roll device for extracting the sheet covered in film onto an exit table.

The abovementioned reel and rolls were cylindrical and had a generatrix length of 30 cm.

The polyethylene film had previously been wound onto the supply reel (placed at the appropriate point in the device) to a thickness of about 3 cm. This reel was unwound manually in such a way as to convey the film between the two press rolls.

A rectangular sheet of PMMA was cut out with dimensions of 47 cm by 23 cm and a thickness of 3 cm.

This sheet was introduced into the device and the motor was started so as to proceed with the application of the film by means of the two press rolls.

The film tension measured by means of the roll fitted with a suitable sensor was about 2 kg.

The adhesion quality of the film applied to the sheet was evaluated by a peel test carried out 24 hours after application of the film to the sheet and after storage of the assembly at 25° C. and 50% relative humidity. The objective of this test was to measure, under specific conditions, the force required to detach the film.

In accordance with this test, a 5 cm wide by 15 cm long rectangular test piece was cut from the sheet covered in the film. This test piece was fixed vertically in the stationary jaw of a tensile testing machine. The film was debonded at one end over a length of about 10 cm, and this end was fixed in the moveable jaw of the machine. The moveable jaw was moved vertically upward at a constant speed (fixed at 30 mm/min), debonding the free end of the strip of film at an angle of 180° to the test piece. A force sensor integrated into the moveable jaw measured the force corresponding to this displacement, which was expressed in grams and called the “adhesion value”. This test was adapted from AFERA (European Association for the Self Adhesive Tape Industry) test method 4001 Peel Adhesion of Adhesive Tape on Stainless Steel.

The adhesion value of the film to the sheet measured by this test was 42 g.

### EXAMPLE 2

Application of a simultaneously coextruded and biaxially oriented film comprising polypropylene to a PMMA sheet.

1. Preparation of the Coextruded Film:

A coextruded film having the composition indicated below was prepared, it was simultaneously biaxially oriented using the simultaneous biaxial drawing method described above, while operating under the following conditions:
layer a): extruder temperature from 250° C. to 270° C.; extruder rotational speed of 160 rpm;
layer c): extruder temperature from 250° C. to 270° C.; extruder rotational speed of 19 rpm;
layer b): extruder temperature from 210° C. to 250° C.; extruder rotational speed of 38 rpm;
head temperature: 250° C.;
quenching roll and bath temperature: 30° C.;
temperature of the IR preheating unit from 100° C. to 320° C.;
temperature of the drawing oven from 160° C. to 170° C.; and
power of the corona treatment device: 50 W/cm.

On the line, the following draw parameters were used: longitudinal draw ratio from 4.5 to 6; transverse draw ratio from 6.0 to 9.

The coextruded film had the following composition:
outer layer c): polypropylene homopolymer with an MFI=3, known commercially under the trademark STAMYLAN®P 15E10FB (DSM), thickness 0.8 μm;
central layer a): polypropylene homopolymer with an MFI=2, known commercially under the trademark MOPLEN®HP522H;
adhesive layer b): EVA, vinyl acetate content of 2.5 mol %; MFI=2.2; thickness 0.8 μm.

The surface of layer b) of the film was treated by high-frequency electrical discharges (“corona” treatment) with an intensity of 50 W/cm.

The overall film thickness was 30 μm. Its coefficient of deformation was 1% and its haze 2.06.

2. Application of the Film Prepared in This Way to the PMMA Sheet:

Example 1 was repeated, but replacing the polyethylene film with the film prepared in accordance with paragraph 1.

The measured film tension was 0, to within the measurement uncertainties.

The adhesion value of the film was 27 g.

Thus it appears that the film of example 2 has, in the machine that applies it to the sheet, a tension below that of the film of example 1, and is therefore less likely to be deformed, particularly since it has a much lower coefficient of deformation. These properties make it particularly suitable as masking film, especially on account of a low shrinkage risk. In addition, its adhesion value is comparable to that of the polyethylene film.

Lastly, on account of its haze value being nearly five times lower than that of the film of example 1, the film of example 2 is particularly well suited for visual inspection of the defects likely to affect the surface of thermoplastic sheets without removing the masking film.

1-12. (canceled)

13. A protected thermoplastic composition comprising a thermoplastic sheet and directly adhered thereto a multilayer film for the protection of said sheet of thermoplastic, wherein said multilayer film is a simultaneously coextruded and biaxially oriented film, comprising the following layers:
a) an polypropylene layer comprising:
1) a polypropylene homopolymer; or
2) a copolymer of propylene and ethylene and/or α-olefins having 4 to 8 carbon atoms,
said polypropylene layer having an MFI (Melt Flow Index, ISO 1133, 230° C./10 min) of at least 1.5 to 10 g/10 min;
b)an adhesive layer directly between and in contact with said polypropylene layer on one side and said thermoplastic sheet on the other side comprising:
1) copolymers of ethylene and C₃ to C₁₂ α-olefins, with a density (ASTM 792) of 0.887 g/cm³ to 0.916 g/cm³; or
2) ethylene/vinyl acetate (EVA) copolymers in which the vinyl acetate monomer represents from 2 to 14 mol %,
said ethylene copolymers having an MFI (ASTM D 1238, 190° C./2.16 kg) of 1 to 10 g/10 min, and wherein said layer b) is polarized on the surface.

14. The protected thermoplastic composition of claim 13, wherein said polypropylene layer a) has a MFI of from 2 to 4 g/10 min, and said adhesive layer b) has an MFI of 2 to 6 g/10 min.

15. The protected thermoplastic composition of claim 13, wherein said adhesive layer comprises copolymers of ethylene and C₄ to C₈ α-olefins, with a density (ASTM 792) of 0.887 g/cm³ to 0.916 g/cm³; or

16. The protected thermoplastic composition of claim 13, wherein the overall thickness of the multilayer film is between 15 μm and 50 μm.

17. The protected thermoplastic composition of claim 16, wherein the overall thickness of the multilayer film is between 15 μm and 35 μm.

18. The protected thermoplastic composition of claim 17 wherein the overall thickness of the multilayer film is between 20 μm and 30 μm.

19. The protected thermoplastic composition of claim 13 wherein the thickness of the adhesive layer b) varies between 5 and 30% of the overall multilayer film thickness.

20. The protected thermoplastic composition of claim 19 wherein the thickness of the adhesive layer b) varies between 5 and 20% of the overall multilayer film thickness.

21. The protected thermoplastic composition of claim 13 layer a) comprises a propylene homopolymer.

22. The protected thermoplastic composition of claim 13 wherein layer b) comprises an ethylene/vinyl acetate copolymer.

23. The protected thermoplastic composition of claim 13 wherein the multilayer coextruded film further comprises a non-adhesive outer layer c) laid on the surface of the polypropylene layer a) that is opposite the adhesive layer b).

24. The protected thermoplastic composition of claim 13 wherein the polarization of the adhesive layer b) is obtained by corona treatment.

25. The protected thermoplastic composition of claim 13 wherein said thermoplastic composition is selected from the group consisting of acrylic resins, polycarbonate, polyethylene terephthalate, and polyethylene glycol terephthalate.

26. The protected thermoplastic composition of claim 25 wherein said thermoplastic composition is polymethylmethacrylate (PMMA).

27. The protected thermoplastic composition of claim 13 wherein

28. The protected thermoplastic composition of claim 13 comprising an article formed by thermoforming said protected thermoplastic sheet.

29. A method for the protection of a sheet of thermoplastic, comprising:
a) simultaneously coextruding and biaxially orienting multilayer film, comprising the following layers:
1) an polypropylene layer comprising:
a. a polypropylene homopolymer; or
b. a copolymer of propylene and ethylene and/or α-olefins having 4 to 8 carbon atoms,
said polypropylene layer having an MFI (Melt Flow Index, ISO 1133, 230° C./10 min) of at least 1.5 to 10 g/10 min;
2) an adhesive layer directly between and in contact with said polypropylene layer on one side and said thermoplastic sheet on the other side comprising:
a. copolymers of ethylene and C₃ to C₁₂ α-olefins, with a density (ASTM 792) of 0.887 g/cm³ to 0.916 g/cm³; or
b. ethylene/vinyl acetate (EVA) copolymers in which the vinyl acetate monomer represents from 2 to 14 mol %,
said ethylene copolymers having an MFI (ASTM D 1238, 190° C./2.16 kg) of 1 to 10 g/10 min, and wherein said layer b) is polarized on the surface.
b) tensioning said film;
c) applying said film to the thermoplastic sheet by bringing the adhesive layer b) into contact with said sheet then passing the assembly between two cylindrical rolls rotating in opposite directions.
